(19) United States
(12) Patent Application Publication
(10) Pub. No.: US 2009/0271740 A1
(43) Pub. Date: Oct. 29, 2009

(54) SYSTEM AND METHOD FOR MEASURING USER RESPONSE

(76) Inventors: Lisa M. Ryan-Hutton, Newburgh, IN (US); Douglas E. Crang, North Point (HK)

Correspondence Address: BARNES & THORNBURG LLP, 11 SOUTH MERIDIAN, INDIANAPOLIS, IN, 46204, US

(21) Appl. No.: 12/429,733

(22) Filed: Apr. 24, 2009

Related U.S. Application Data
(60) Provisional application No. 61/125,571, filed on Apr. 25, 2008.

(51) Int. Cl. G06F 3/048

(52) U.S. Cl. 715/835

(57) ABSTRACT

A system and method for measuring user response to a stimulus, such as an advertisement, includes displaying the stimulus to the user, displaying a color bar to the user, and receiving a selection of a color from the color bar made by the user in response to the stimulus. The color bar may include a plurality of colors of various intensities and tones. Based on the color selected by the user, an emotional response metric to the stimulus may be determined. The emotional response metric may include, for example, the percentage of users selecting intense colors in response to the stimulus, the percentage of users selecting a particular tone of colors in response to the stimulus, and/or the percentage of users selecting a particular color in response to the stimulus.

This utility patent application claims priority to and the benefit of U.S. Provisional Patent Application Ser. No. 61/125,571 entitled “Method and Apparatus for Measuring User Response” by Lisa R. Hutton et al., which was filed on Apr. 25, 2008, the entirety of each of which is expressly incorporated herein by reference.

### TECHNICAL FIELD

The present disclosure relates generally to systems and methods for determining a user response to stimulus and, more particularly, to systems and method for determining and measuring a user's emotion response to stimulus.

### BACKGROUND

The psychology of color as it relates to human emotion, mood, and feelings associated with specific colors is generally known and includes the specific human emotions relating to color using emotion measurement systems based on verbal word pairs, images, and computer character depictions. Thus, it is known that human emotions can be measured, specific human emotions have been measured for color(s), and, color evokes emotions. Existing metrics of emotion include perceptions of emotions, verbalizations of emotion, and content elements relating to emotion. Thus, current emotion measurement tools generally employ images, words, or computer generated characters. However, it is not known to use color itself as an emotion measurement tool; one that identifies specific emotions evoked by a stimulus such as visual, auditory, or tactile stimulus, the strength of those emotions and the overall emotion tone.

### SUMMARY

According to one aspect, a computer may include a display, a processor, and a memory device. The memory device may be electrically coupled to the processor and may have stored therein a plurality of instructions that, when executed by the processor, cause the processor to display a stimulus to a user on the display. The stimulus may be embodied as, for example, an advertisement for a particular product or service or for a particular brand of products a political debate, a concert, a play, a musical, a dance, a show, a work of art, a work of literature, a movie, a song, an odor, a character, or other stimulus that may be perceived by the user. Additionally, the stimulus may be embodied as a video, collection of images, or the like. The plurality of instructions may also cause the processor to display a color bar to the user on the display. The color bar may include a plurality of different colors. Additionally, the plurality of instructions may cause the processor to display a question related to the advertisement to the user on the display. The question may request the user to select one of the colors of the color bar. The plurality of instructions may also cause the processor to receive a selection of one of the colors of the color bar made by the user in response to the question.

In some embodiments, the color bar may include a plurality of icons. In such embodiments, each icon may have a color corresponding to one of the plurality of different colors. For example, the color bar may include a grid of colored icons. The grid may have a plurality of columns and at least two rows. Each column of the grid may correspond to a different color. The grid may include, for example, a first row and a second row of colored icons. In such embodiments, the color of each colored icon of the second row may have a lesser intensity than the color of the corresponding colored icon of the first row of the same column. In such embodiments, the plurality of instructions may also cause the processor to receive selections from a plurality of users and determine a percentage value indicative of the percentage of users that chose a particular intensity.

Additionally, in some embodiments, each colored geometric shape may be arranged in the grid based on the tone of the color of the colored icon. For example, each colored icon having a warm color tone may be positioned toward a first end of the grid, each colored icon having a cool color tone may be positioned toward the center of the grid, and each icon shape having a neutral color tone may be positioned toward a second end of the grid opposite the first end. In such embodiments, the plurality of instructions may also cause the processor to receive selections from a plurality of users and determine a percentage value indicative of the percentage of users that chose a particular color tone.

In some embodiments, the color bar may include the following colors positioned in the following left-to-right arrangement: red, orange, yellow, pink, green, blue, purple, black, and white. Additionally, in some embodiments, each color of the color bar may be defined according to a predetermined 24-bit RGB representation. For example, in one particular embodiment, the color bar includes colors defined by the following 24-bit RGB representations: (255, 0, 0); (255, 167, 167); (255, 102, 0); (255, 180, 129); (255, 255, 0); (255, 255, 129); (0, 176, 0); (133, 255, 133); (0, 0, 255); (139, 139, 255); (153, 0, 204); (186, 140, 220); (255, 0, 204); (255, 175, 240); (0, 0, 0); (173, 173, 173); (255, 255, 255); and (240, 240, 240).

Additionally, in some embodiments, the plurality of instructions may cause the processor to receive selections from a plurality of users and determine a percentage value indicative of the percentage of users that chose a particular color. Further, the plurality of instructions may cause the processor to associate an emotion or emotions with each color of the color bar.

According to another aspect, a machine readable medium may include a plurality of instructions, that in response to being executed, result in a computing device: displaying a stimulus to a user on the display, displaying a color bar including a plurality of icons arranged in the a grid to the user on the display, and receiving a selection of one of the icons by the user in response to the stimulus. Each icon may be selectable by the user to indicate a selection of a color associated with the icon.

In some embodiments, the grid may include a plurality of columns and each column may correspond to a different color. The grid may also include a first row corresponding to high intensity colors and a second row corresponding to low intensity colors. Additionally, the icons may be arranged in the grid based on the tone of the color of each icon. In some embodiments, the color bar may include icons having the following colors: red, orange, yellow, pink, green, blue, purple, black, and white. Additionally, in some embodiments, each color of the icons may be defined according to a predetermined 24-bit RGB representation.

According to a further aspect, a method for determining an emotional response of a user to a stimulus may include providing the stimulus to the user and providing a color bar to the user. The color bar may include plurality of different colors. The method may also include identifying a color selected by the user in response to the stimulus and determining an emotional response metric of stimulus based on the color selected by the user. In some embodiments, providing the stimulus to the user may include displaying an advertisement to the user. Additionally, in some embodiments, providing a color bar to the user may include providing a print medium to the user, the print medium having indicia located thereon representative of the color bar.

According to yet a further aspect, a survey instrument may include a print medium substrate and a plurality of differently colored icons defined on the print medium substrate. The plurality of differently colored icons may be arranged in a grid. The survey instrument may also include indicia defined on the print medium substrate, the indicia requesting a user of the survey instrument to select one of the differently colored icons. In some embodiments, the plurality of differently colored icons may be arranged in a grid having a plurality of columns and at least two rows, each column of the grid corresponding to a different color. Additionally, in some embodiments, the grid may include a first row and a second row of colored icons. In such embodiments, the color of each colored icon of the second row having a lesser intensity than the color of the corresponding colored icon of the first row of the same column. Additionally, in some embodiments, each colored icon having a warm color tone is positioned toward a first end of the grid, each colored icon having a cool color tone is positioned toward the center of the grid, and each colored icon having a neutral color tone is positioned toward a second end of the grid opposite the first end. Further, in some embodiments, the color bar includes the following colors positioned in the following left-to-right arrangement: red, orange, yellow, pink, green, blue, purple, black, and white.

### BRIEF DESCRIPTION OF THE DRAWINGS

The detailed description particularly refers to the following figures, in which:

FIG. 1 is a simplified diagram of one embodiment of a system for measuring user response;

FIG. 2 is a simplified flow diagram of a method for transmitting and receiving data that may be executed by a server of the system of FIG. 1;

FIG. 3 is a simplified flow diagram of a method for determining a user response that may be executed by a client of the system of FIG. 1;

FIG. 4 is an illustration of one embodiment of an emotion question and associated color bar presented to a user during the execution of the method of FIG. 3;

FIG. 5 is an illustration of one embodiment of another emotion question and associated color bar presented to a user during the execution of the method of FIG. 3;

FIG. 6 is an illustration of one embodiment of a color bar having nine separate colors and the arrangement of such colors;

FIG. 7 is an illustration of one embodiment of a color bar indicating the arrangement of warm tone colors, cool tone colors, and neutral tone colors;

FIG. 8 is an illustration of one embodiment of a color bar indicating a row of intense colors and a row of non-intense colors;

FIG. 9 is an illustration of one embodiment of a color bar and associated 24-bit RGB representations of each color of the color bar for displaying on a display device and printing on a printer;

FIG. 10 is a chart of one embodiment of emotional descriptors associated with each color included in the color bar of FIGS. 7-9;

FIG. 11 is an illustration of one embodiment of an emotion response metric chart; and

FIG. 12 is an illustration of another embodiment of an emotion response metric chart.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the invention as defined by the appended claims.

Systems and methods for determining a user's response to a stimulus using a color emotion measurement tool are disclosed herein. One illustrative color emotion measurement tool is embodied as a specifically designed color bar and research questions, which are answered as part of a research application and approach as discussed in more detail below. The color emotion measurement tool may be used, for example, by respondents (“users”) who are presented a stimulus and subsequently requested to measure their emotions using the color emotion measurement tool. The stimulus may be embodied as any type of stimulus perceivable by the user. For example, the stimulus may be embodied as an advertisement for a product or brand of products, a political debate, a concert, a play, a musical, a dance, a show, a work of art, a work of literature, a movie, a song, an odor, or other stimulus that may be perceived by a respondent in any way (e.g., seen, tasted, smelled, touched, felt, heard or otherwise perceived).

The color emotion measurement tool and associated research questions, as well as the stimulus, may be presented to the user via a display device such as a computer or computer terminal, via print media, or live (e.g., by a person, animal, or other entity). Illustratively, the outputs of the color emotion measurement tool may include, for example, data indicative of emotion intensity, emotion tone, emotion adjectives, and/or a research interpretation of such results. The output metrics may be used in the analysis of the emotion profile of the stimulus viewed by the use. In some embodiments, the emotion metrics may be statistically tested in order to determine if significant differences exist between various types of communications or the environments in which the communications are viewed.

In use, as discussed in more detail below, the color emotion measurement tool provides indicia of the degree to which the emotional experience affects user(s) attitudes toward the stimulus (e.g., advertisement). The non-cognitive color emotion measurement tool also provides data indicative of the type and intensity of emotions spontaneously evoked in the respondent by viewing a marketing communications.

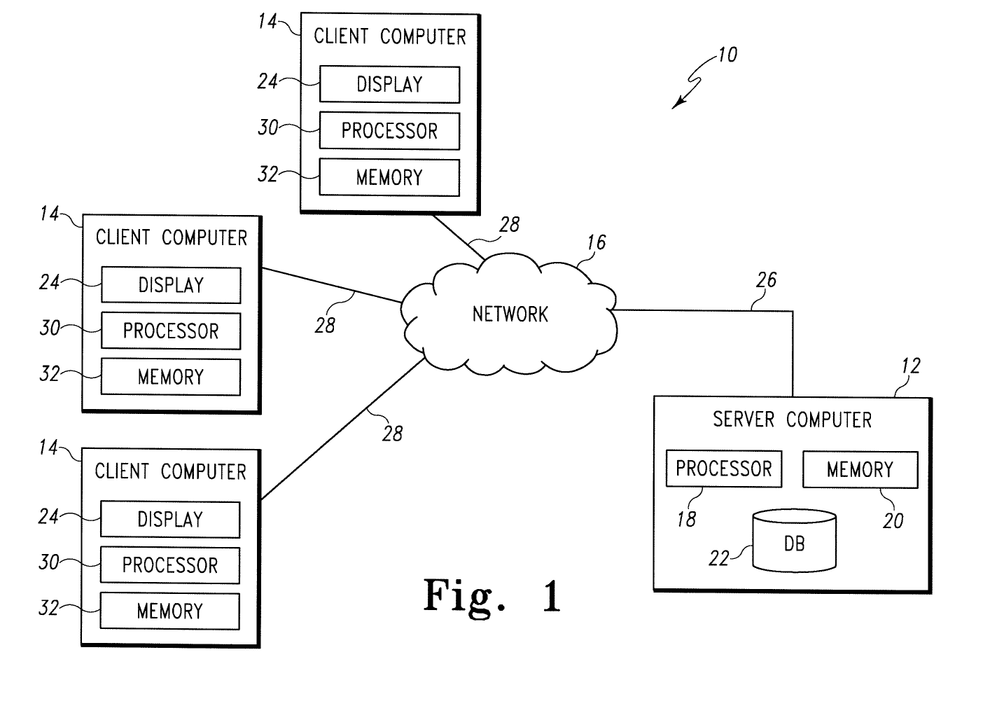

One illustrative embodiment of a system and method for measuring a user's response is described below in regard to FIG. 1. In the illustrative example, an advertisement is displayed to a user on a display screen of a computer. However, as discussed above, it should be appreciated that in other embodiments, other types of stimulus may be used. Additionally, the stimulus, the color emotion measurement tool, and/or the research questions may be presented to the user using a print media, other physical medium, or other physical forms (e.g., forms that can be smelled, tasted, felt, seen, or heard by the user) rather than a display in other embodiments.

Referring to FIG. 1, a system 10 for determining a user's response to a stimulus, such as an advertisement for a product or brand of products, includes a server computer or system 12 coupled with a number of client computers 14 via a network 16. The server computer 12 includes a processor 18 and a memory device 20. The processor 18 is electrically coupled with the memory device 20 via suitable communication links such as wires, printed circuit board (PCB) traces, communication buses, or the like. The processor 18 may be embodied as any type of processing device or collection of devices configured to perform the functions described herein such as, for example, a specifically-programmed general purpose processor, a microcontroller, an application specific integrated circuit (ASIC), and/or a collection of discrete circuitry. The memory device 20 may be embodied as any type of memory device capable of storing data such as program code, data values, and the like. The memory device 20 may include any number of non-volatile memory devices such as a read only memory (“ROM”), any number of volatile memory devices such as a random access memory (“RAM”), and/or other types of memory storage devices.

The server computer 12 may also include a database 22. The database 22 may be embodied as any type of database, electronic library, and/or file storage location. For example, the database 22 may be embodied as a structured database or as an electronic file folder or directory containing a number of separate files and an associated “look-up” table. Further, the database 22 may be stored on any suitable device. For example, the database 22 may be stored in a set of memory locations of, for example, the memory device 20 and/or a stored on a separate storage device such as a hard drive or the like. Additionally or alternatively, the database 22 may be embodied as a remote database located apart from the computer system 12. For example, the computer system 12 and the database 22 may be located in separate rooms or facilities from each other.

Each of the client computers 14 include a number of components commonly associated with such machines. For example, similar to the server computer 12, each of the client computers 14 includes a display or display device 24, a processor 30, and a memory device 32. The display 24 may be embodied as any type of device capable of displaying images, text, and/or other visual communication to a user. For example, the display 24 may be embodied as a liquid crystal display (LCD), a cathode ray tube display (CRT), or the like. The processor 30 is electrically coupled with the memory device 32 via suitable communication links such as wires, printed circuit board (PCB) traces, communication buses, or the like. The processor 30 may be embodied as any type of processing device or collection of devices configured to perform the functions described herein such as, for example, a specifically-programmed general purpose processor, a microcontroller, an application specific integrated circuit (ASIC), and/or a collection of discrete circuitry. The memory device 32 may be embodied as any type of memory device capable of storing data such as program code, data values, and the like. The memory device 32 may include any number of non-volatile memory devices such as a read only memory (“ROM”), any number of volatile memory devices such as a random access memory (“RAM”), and/or other types of memory storage devices. Users may interact with the client computers 14 using suitable input devices such as a keyboard, mouse, and/or touch-screen electronics associated with the display 24.

In some embodiments, the server computer 12 may be maintained by an advertisement analysis company. The client computer 14 may also be maintained by an advertisement analysis company and may be located in, for example, a testing room or facility. Alternatively, one or more of the client computers 14 may be under the control of one of the users (e.g., consumers) of the client computers 14 and located at, for example, the home of the user. It should be appreciated that although only three client computers 14 are illustrated in FIG. 1, the system 10 may include any number of client computers 14.

As shown in FIG. 1, the server computer 12 is coupled to the network 16 via a communication link 26, whereas the remote computers 14 are coupled to the network 16 via a number of communication links 28. It should be appreciated that each of the communication links 26, 28 may be provided as any number or type of data link including both wired and wireless data links. Moreover, it should also be appreciated that one or more intervening modems (not shown), data routers (not shown), and/or internet service providers (“ISPs”) (not shown) may be used to transfer the data between the computer system 12, the remote computers 14, and the network 16.

The network 16 of the present disclosure may be embodied as any type of network such as a local area network (LAN), a wide area network (WAN), or a publicly-accessible global network such as the Internet. Additionally, the network 16 may be a wired network, a wireless network, or a combination thereof and may use any communication technology and protocol to transfer data between the computer system 12 and the remote computers 14.

In operation, the server computer system 12 is configured to determine one or more emotion response metrics of a number of users in response to a stimulus such as an advertisement of a product or brand. To do so, the server computer 12 transmits and receives data from the client computers 14 via the network 16. In some embodiments, the users of the client computers 14 may interact with the computer system 12 via the remote computers 14 to, for example, make selections and provide data to the computer system 12. Alternatively, as discussed in more detail below, the server 12 may transmit the emotion response data to the client computers 14, which are configured to collect the user's response to the stimulus as discussed below. That is, user's response or selections to the stimulus may be collected, stored, and/or analyzed on the client computers 14 and/or the server computer 12.

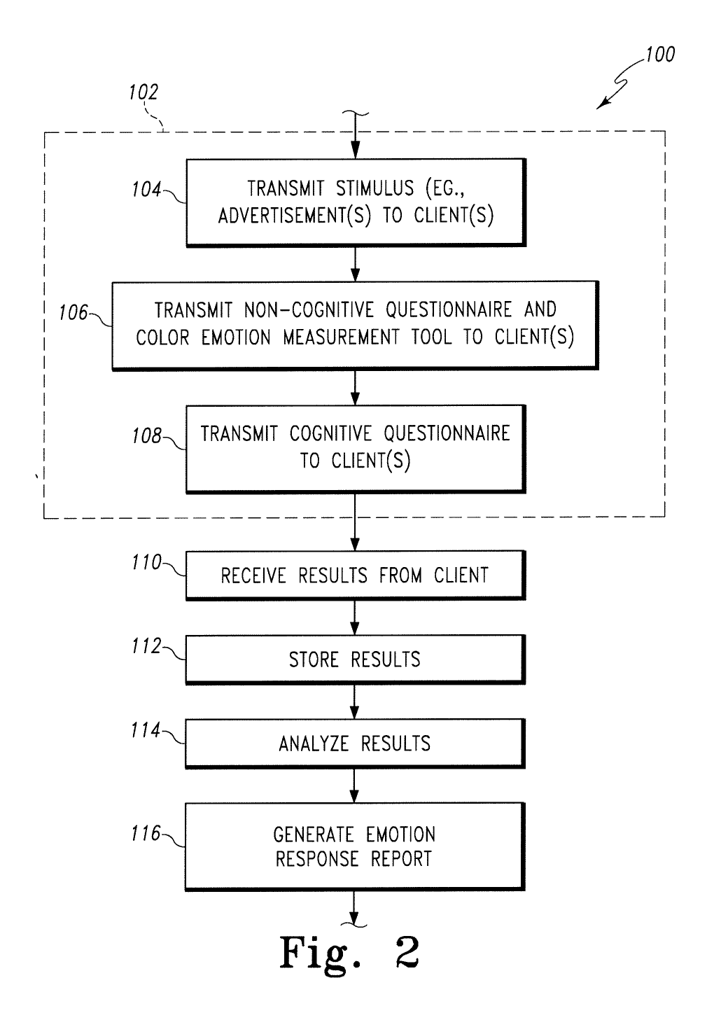

Referring now to FIG. 2, in one embodiment, the server computer 12 executes a method 100 for transmitting and receiving emotion response data. The method 100 begins with a block 102 in which the server computer 12 transmits emotion response measurement data to the client computers 14. The emotion response measurement data may include the stimulus to be viewed or otherwise experienced by the user, a non-cognitive questionnaire, and a cognitive questionnaire. For example, as shown in FIG. 2, the block 102 may include a block 104 in which the server computer 12 transmits one or more advertisements to the client computers 14. The advertisements may be embodied as any type of marketing communications such as a visual advertisement including still-frame or moving images, auditory advertisements such as radio commercials, or the like. Additionally, in some embodiments, the advertisements may be embodied as print advertisements. For example, the advertisements may be printed and supplied to the users as hard-copies of the advertisements. Additionally, in some embodiments, other types of stimuli may be used in place of advertisements. For example, in some embodiments, the system 10 may be used to measure a user's emotion response to live stimulus, such as a political debate, a concert, a play, a musical, a dance, a show, a work of art, a work of literature, a movie, a song, an odor, or other stimulus that may be perceived by the user (i.e., tester) of the client computers. Additionally, as discussed above, such live stimulus may be embodied as visual, auditory, taste, tactile, and/or olfactory stimulus and may be presented to the user on the client computer 14 or via a hard-copy printout, other physical medium, or the like.

In block 106, the server computer 12 transmits the non-cognitive questionnaire to the client computers 14. The non-cognitive questionnaire may include any number of non-cognitive research questions, which are typically related to the advertisement(s) or product/brand advertised, and an associated color emotion measurement tool, which is usable by the user to respond to the non-cognitive research questions. In one embodiment, the non-cognitive research questions directed to, for example, the overall feeling the user has toward the advertisement, the product advertised, and/or the brand of the product advertised. As discussed in more detail below, the color emotion measurement tool may be embodied as a color bar having a plurality of colors selectable by the user in response to the non-cognitive research question.

In some embodiments, the server computer 12 may also transmit a cognitive questionnaire to the client computers 14 in block 108. The cognitive questionnaire may include any number of cognitive research questions. For example, such cognitive research questions may request the user to rate the advertisement or product advertised or the like.

Once the server computer 12 has transmitted the emotion response data (e.g., the non-cognitive questions, color emotion measurement tool, and any cognitive questions) to the client computers 14, the server computer 12 may be configured to receive result data from the clients 14 in block 110. The result data may include the selections made by the user in response to the non-cognitive and cognitive questions). In block 112, the server computer 12 stores the result data. The server computer 12 may store the result data in, for example, the database 22.

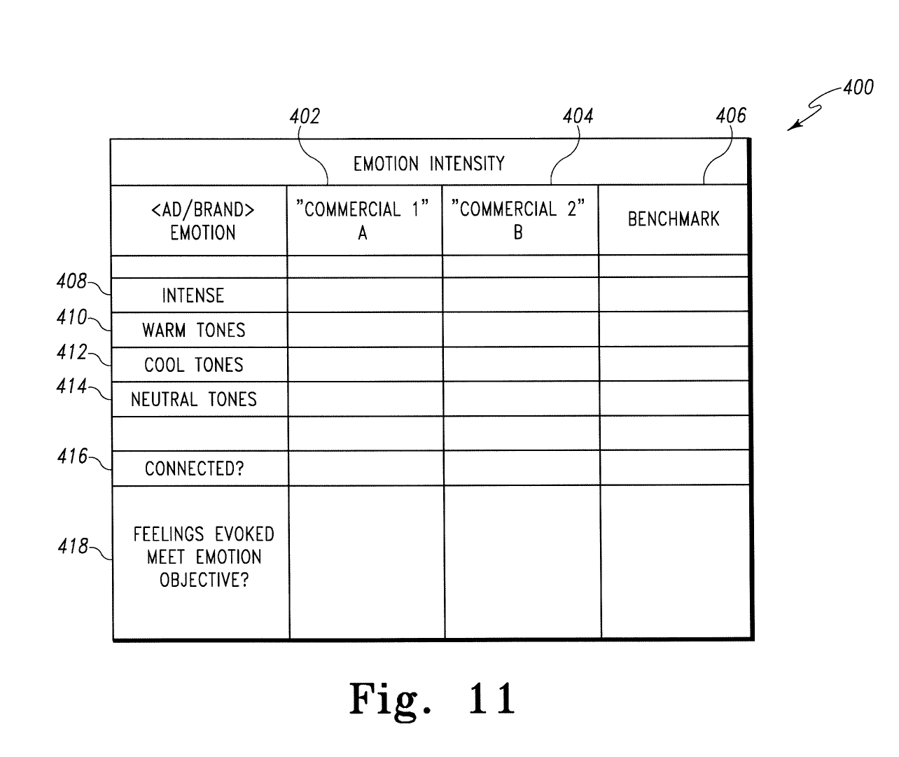

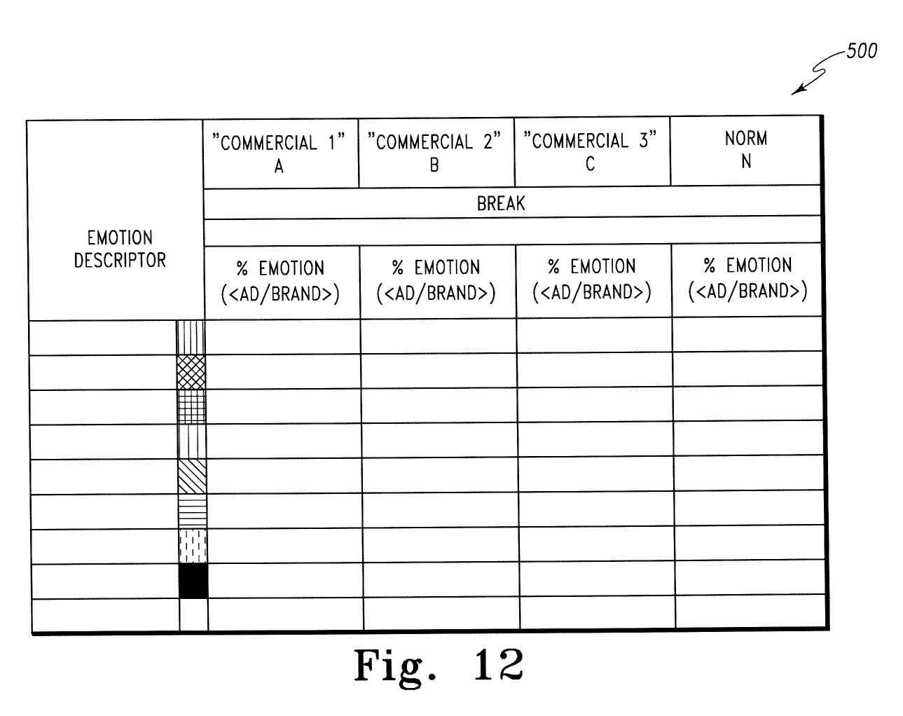

Subsequently in blocks 114 and 116, the server computer 12 may analyze the result data received from each of the client computers 14 and/or other users. The server computer 12 may generate an emotional response report, which may include an emotional response metric. For example, as discussed in more detail below in regard to FIGS. 11 and 12, the emotional response metric may include data indicative of the percentage of users that chose intense or non-intense colors in response to the stimuli (e.g., an advertisement), the percentage of users that chose warm, cool, or neutral colors in response to the stimuli, the percentage of users that chose a specific color in response to the stimuli, and/or a combination thereof.

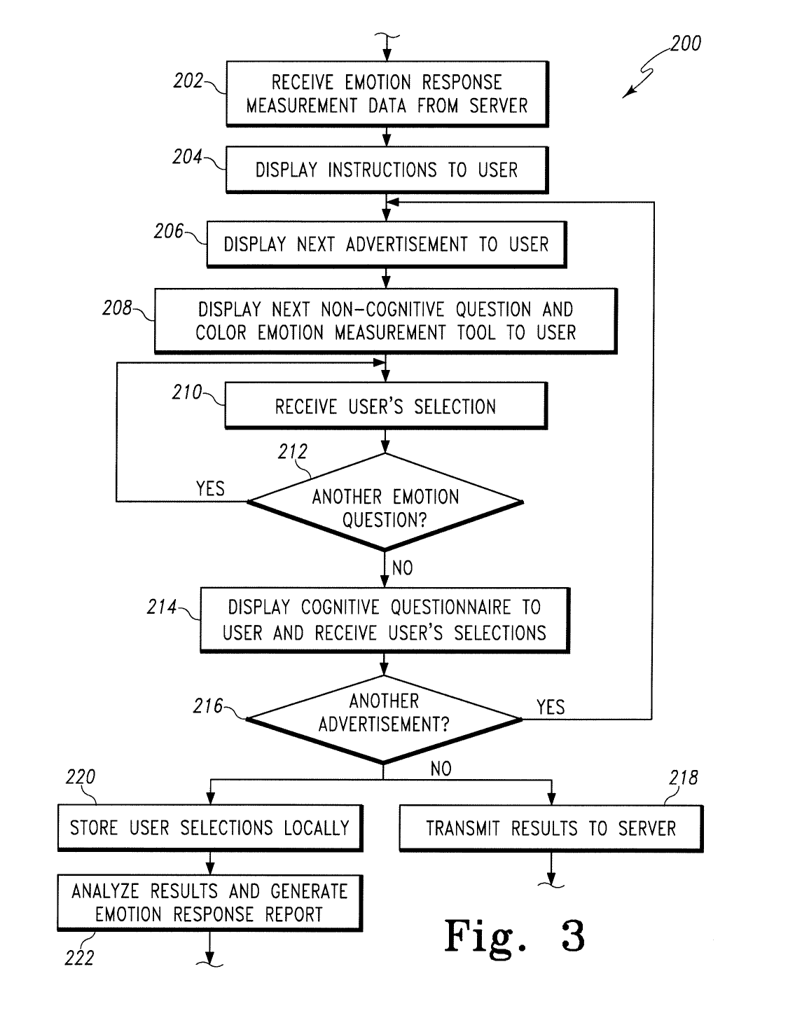

Referring now to FIG. 3, each of the client computers 14 may execute a method 200 for determining a user response. The method 200 may begin with block 202 in which the client computer 14 receives the emotion response measurement data from the server machine 12. As discussed above, the emotion response measurement data may include the stimulus to be viewed or otherwise experienced by the user, a non-cognitive questionnaire, and/or a cognitive questionnaire. In block 204, any instructions regarding how to participate in the research and/or supply answers to the questionnaire is displayed or otherwise provided to the user (e.g., such instructions may be provided as a hard-copy printout).

In block 206, the client computer 14 displays the next advertisement or other stimuli to the user. In embodiments wherein the stimulus is embodied as an advertisement, the client computer 14 may display the advertisement to the user via the display 24. Once the user has viewed the advertisement, the non-cognitive questionnaire is displayed to the user in block 208. As discussed above, the non-cognitive questionnaire may include any number of non-cognitive research questions and an associated color emotion measurement tool, which is usable by the user to respond to the non-cognitive research questions. The non-cognitive research questions typically relate to the advertisement(s), the product(s) advertised, and/or the brand of the product(s) advertised. Additionally, the non-cognitive research questions may be directed to the overall feeling the user has toward the advertisement, the product advertised, and/or the brand of the product advertised.

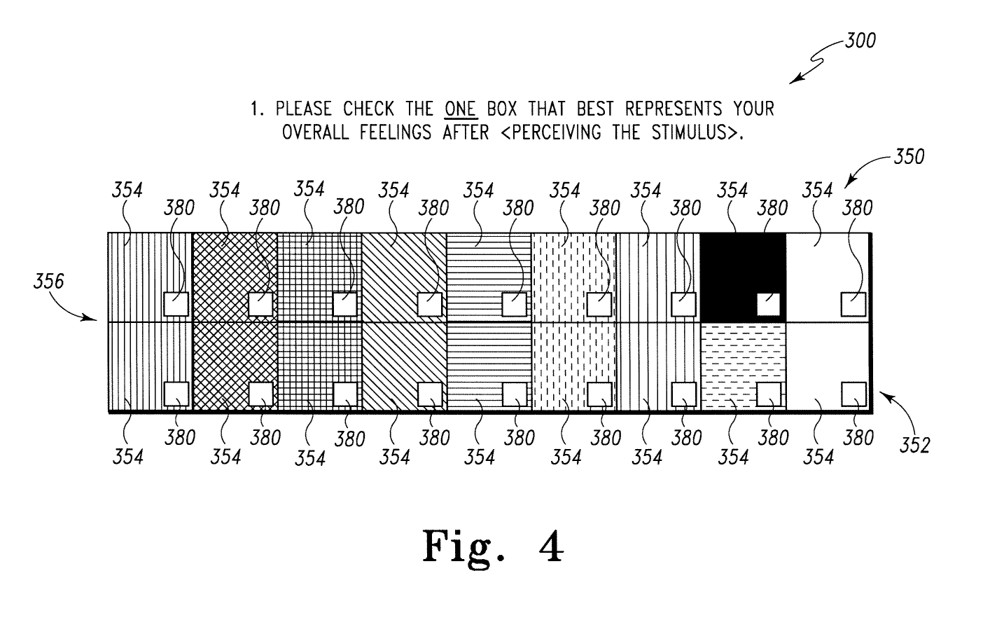

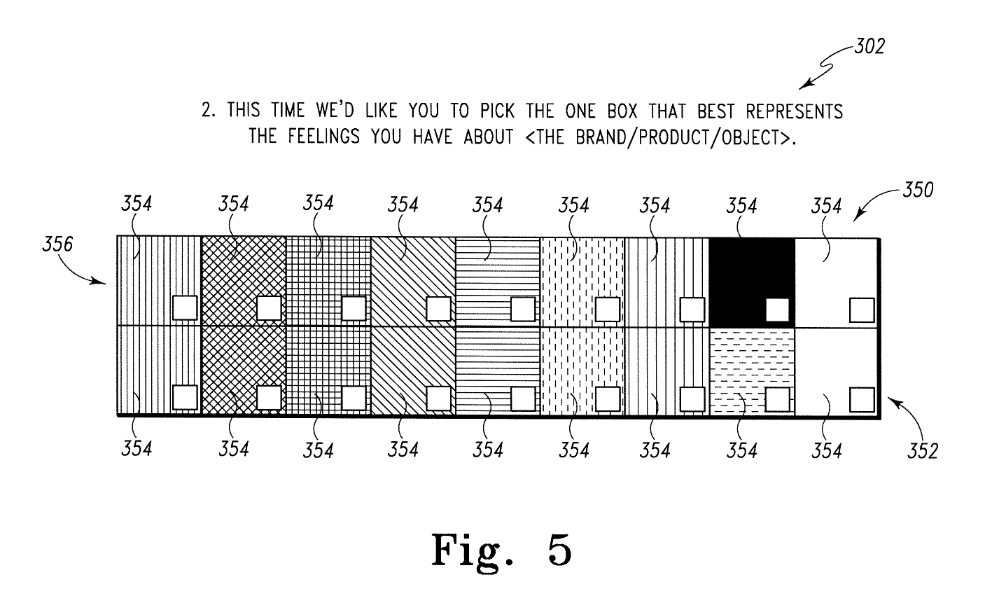

For example, as shown in FIGS. 4 and 5, the user may be presented with a non-cognitive research question 300, 302 and a color emotion measurement tool 350 usable by the user to respond to the question 300. In the illustrative embodiment, the color emotion measurement tool 350 is embodied as a color bar 352 having a plurality of different colors. In one embodiment, as illustrated in FIGS. 4 and 5, the color bar 352 includes a plurality of icons 354, each icon 354 having a different color (or different intensity as discussed below). The icons 354 are illustratively embodied as colored rectangles, but may have other geometric shapes in other embodiments. For example, in some embodiments, the icons 354 may be embodied as colored circles, hexagons, squares, etc. The icons 354 are arranged in a grid 356. The grid 356 illustratively includes nine columns and two rows, but may have additional or less columns and rows in other embodiments. Additionally, the color bar 352 may include icons 354 positioned in alternative arrangements in other embodiments. For example, the color bar 352 may include icons 354 arranged in a circular pattern in some embodiments. As such, the color bar 352 may or may not have a substantially rectangular shape depending on the particular embodiment.

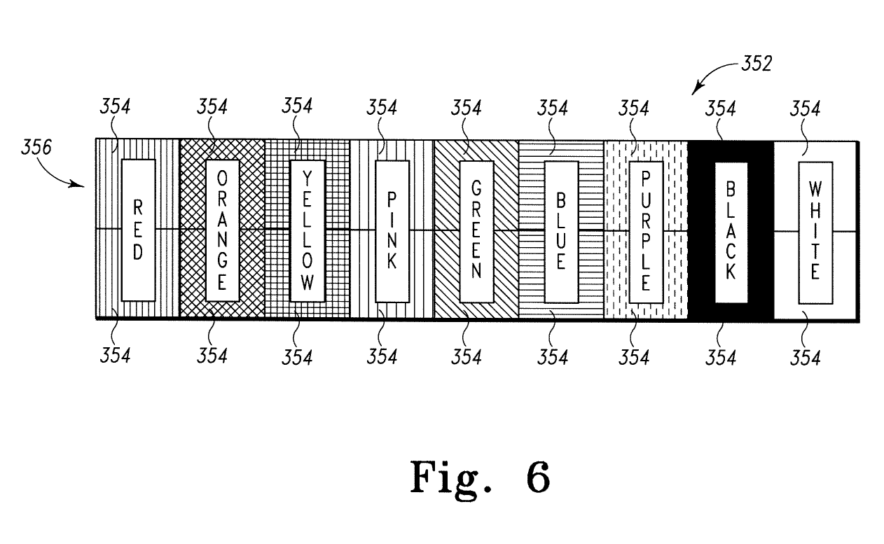

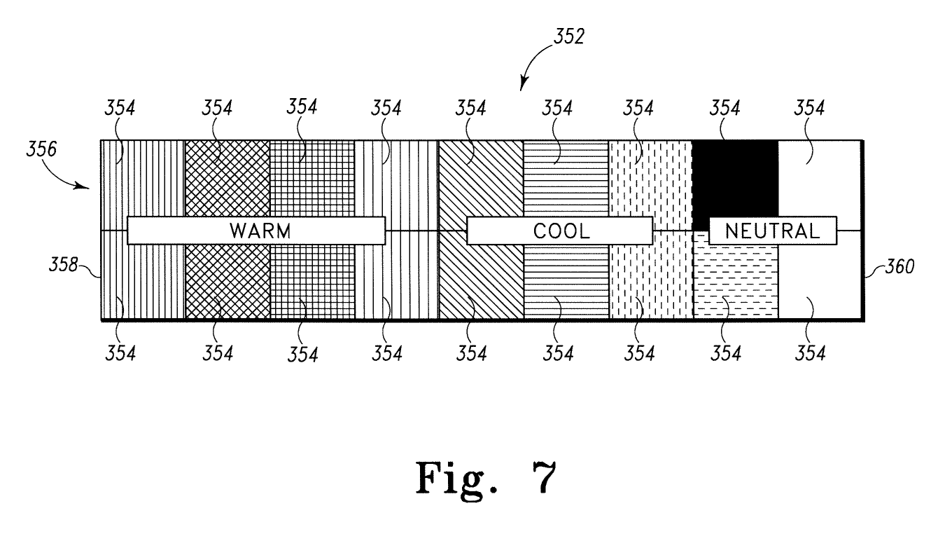

As illustrated in FIG. 6, each column of the grid 356 corresponds to a particular color. In the illustrative embodiment, the color bar 352 includes the following colors: red, orange, yellow, pink, green, blue, purple, black, and white. However, the color bar 352 may include other colors in other embodiments. Additionally, as illustrated in FIG. 7, the colors are grouped or positioned within the grid 356 based on the tone of the color. For example, in the illustrative embodiment, colors having a warm tone are positioned toward an end 358 of the grid 356, colors having a cool tone are positioned toward the center of the grid 356, and colors having a neutral tone are positioned toward an end 360 of the grid 356 opposite the end 358. In other embodiments, colors having common tonal quality may be positioned in other arrangements within the grid 356. Colors that may be identified as having a warm tone include red, orange, yellow, and pink. Colors that may be identified as having a cool tone include green, blue, and purple. Colors identified as having a neutral tone include black and white.

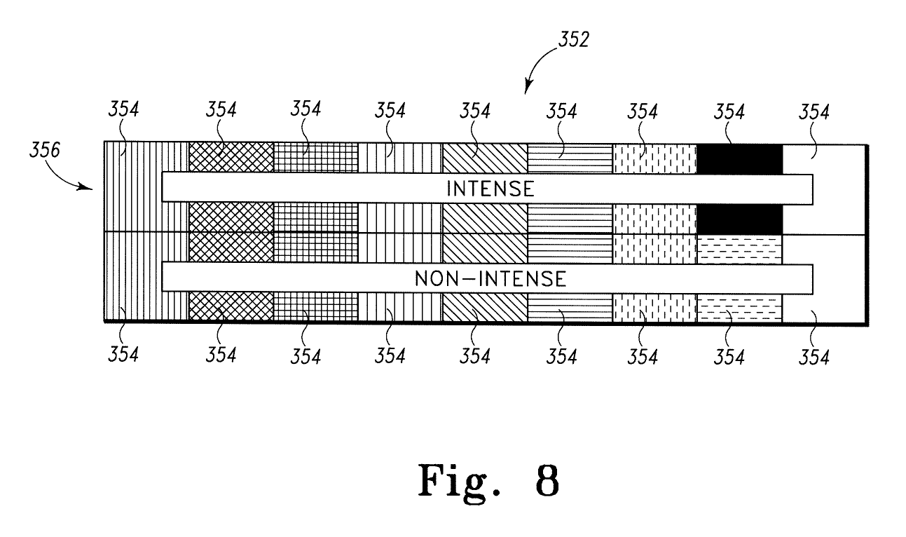

As discussed above, the grid 356 illustratively includes two rows. Although each icon 354 within a column is of the same color, the icons 354 within the second or bottom row have a lesser intensity relative to the icon 354 in the first or top row within the same column as illustrated in FIG. 8. As such, if the first column corresponds to the color red, the icon 354 located in the first row and first column of the grid 356 has a greater intensity than the icon 354 located in the second row and first column (although both icons 354 of the first column are colored red). As such, the grid 356 includes a plurality of colors of various intensities. Again, although the grid 356 illustratively includes only two rows, the grid 356 may include additional rows in other embodiments. As such, the grid 356 may include more than two levels of intensity in some embodiments. For example, the grid 356 may include three rows in which the first row includes colors having a high intensity, the second row includes colors having a medium intensity, and the third row includes colors having a low intensity.

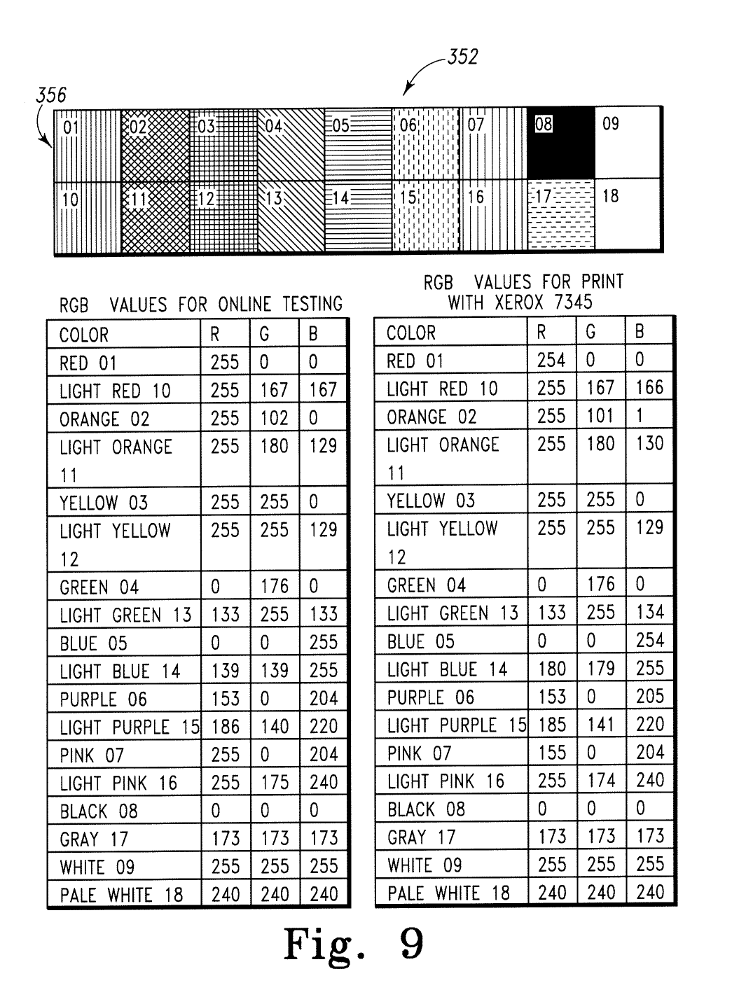

Because various display devices, printers, and/or other output devices may display or otherwise generate colors differently, the colors of the icons 354 is predefined based on a 24-bit RGB representation in some embodiments. For example, one embodiment of a color bar 352 including a plurality of colors defined by predefined 24-bit RGB values is illustrated in FIG. 9. As shown in FIG. 9, each color of each icon 354 has a particular 24-bit RGB value assigned to it. For example, the color red (labeled as 01 on the color bar 352 of FIG. 9) has a 24-bit RGB value of (255, 0, 0) and the color light red (e.g., the red color of less intensity positioned in the second row and labeled as 10) has a 24-bit RGB value of (255, 167, 167). As such, because each color of the color bar 352 is predefined based on an RGB representation, which may be a 24 bit, 32 bit, or other representation, the likelihood that different display devices display the correct color is improved. Additionally, in embodiments wherein the color emotion measurement tool 350 is provided to the user as a print out, similar or different RGB values may be assigned based on the particular printer being used. As such, the resulting color bar 352 printed by the printer includes colors that match or closing match those displayed via a display device, printed by a different type of printer, and/or otherwise provided to other users.

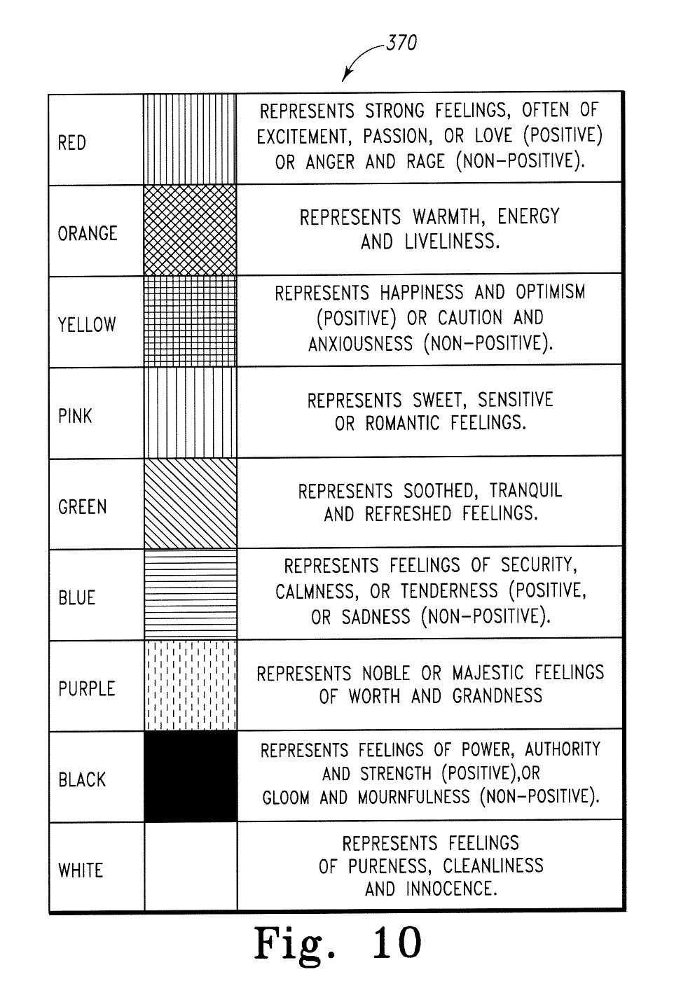

As shown in FIG. 10, in some embodiments, an emotional descriptor 370 may be assigned to each particular color. For example, the color red may be determined to indicate strong feelings of excitement or love. Such descriptors may be determined based on prior research regarding colors and emotions. Additionally, it should be appreciated that such emotional descriptors may vary based on the identify of the users or environmental factors. For example, the descriptors may change based on whether the users are located in North America or Latin America, whether the user is male or female, the ethnicity of the user, the age of the user, etc.

Referring now back to FIG. 3, once the non-cognitive question 300 and color emotion measurement tool 350 have been displayed to the user in block 208, the client machine 14 receives the user's selection in 210. As discussed above, the non-cognitive question 300 requests the user select one of the colors displayed in the tool 350 in response to the question 300 and/or stimulus (e.g., advertisement, product, or brand). To do so, as shown in FIG. 4, the user may select a selection icon or box 380 associated with the icon 354 that corresponds to the color selected by the user. Attentively, in other embodiments, the user may simply select the icon 354 itself such as, for example, by clicking on the icon 354 with a mouse pointer or the like.

Once the user has made a selection on the color emotion measurement tool 350 in response to the non-cognitive question 300, the client machine 14 determines whether an additional non-cognitive question should be presented to the user. If so, the method 200 loops back to block 208 in which the next non-cognitive question (e.g., non-cognitive question 302) and another color emotion measurement tool 350 is displayed to the user. However, if no additional non-cognitive question is to be displayed, the method 200 advances to block 214 wherein any cognitive questions are displayed to the user and the user's response to such cognitive questions are received. As discussed above, the cognitive questions may request the user to rate the advertisement or product advertised or the like.

Once the user has responded to any cognitive questions, the client machine 14 determines whether any additional advertisements or other stimuli should be displayed to the user in block 216. If so, the method 200 loops back to block 206 in which the next advertisement or other stimulus is displayed to the user. If no additional advertisements or other stimulus is to be displayed to the user, the method 200 advances to block 218 and/or block 220. That is, in some embodiments, the client machine 14 may be configured to transmit the user's responses to the server machine 12 in block 218. Additionally or alternatively, the client machine 14 may store the user's responses locally. For example, the client machine 14 may store the user's responses in a database, memory location, or other storage location within the machine 14 or communicatively coupled to the machine 14. Subsequently, after additional user responses have been received, the client machine 14 may be configured to analyze the users' selections and generate an emotion response report in block 222.

As discussed above, the emotional response report may include one or more emotional response metrics. The emotional response metric may include, for example, data indicative of the percentage of users that chose intense or non-intense colors in response to the stimuli (e.g., an advertisement), the percentage of users that chose warm, cool, or neutral colors in response to the stimuli, the percentage of users that chose a specific color in response to the stimuli, and/or a combination thereof. For example, as illustrated in FIG. 11, one embodiment of an emotional response report 400 is directed to the emotional intensity felt by the users. The report 400 may include data directed to the advertisement and/or to the product brand. Additionally, the report 400 may include data related to multiple advertisements or “commercials.” For example, the illustrative report 400 includes a column 402 associated with a first advertisement, a column 404 associated with a second advertisement, and a column 406 associated with a benchmark. The report 400 also includes a row 408 in which the percentage of users selecting an intense color is displayed (e.g., the percentage of users selecting a color from the top row of the color bar 352). The report 400 also includes rows 410, 412, 414 in which the percentage of users selecting colors having a warm tone, a cool tone, and a neutral tone, respectively, is displayed. Additionally, in some embodiments, the report 400 may include additional rows 416, 418 in which a reviewer of the report may provide additional information based on the results presented in the report 400. For example, in row 416 the reviewer may provide their opinion whether the users “connected” with the advertisement or advertised product/brand.

It should be appreciated that various types of reports based on the user's selections may be generated. For example, as illustrated in FIG. 12, a report 500 may be generated that identifies the percentage of users selecting a particular color (with or without regard to the intensity of the color) in response to various commercials. Additionally, in some embodiments, a reviewer may assign an emotional descriptor to each color (see, e.g., FIG. 10). As discussed above, the assigned emotional descriptor may change based on aspects of the users, geographical aspects, and/or other environmental aspects. Accordingly, it should be appreciated, that various types of emotional response metrics may be determined based on the users' emotion response to the advertisements, products advertised, brands advertised, and/or other stimulus. For example, the overall effectiveness of the advertisement may be determined based on the user's emotion response as indicated by the particular colors selected by the user.

It should be appreciated that although the above method 200 has been described in regard to displaying an advertisement to a user on a computer, the method 200 may also be implemented without the use of a computer. That is, the advertisement or other stimulus may be provided to the user as a hard-copy or print-out in some embodiments. Additionally, the emotion response data, such as the non-cognitive questionnaire and color emotion measurement tool, may be provided to the user as a hard-copy, print-out as discussed above. Additionally, as discussed above, although the method 200 has been described in regard to the analysis of advertisements, other types of stimuli may be used in other embodiments. For example, such other stimuli may include, but is not limited to, a political debate, a concert, a play, a musical, a dance, a show, a work of art, a work of literature, a movie, a song, an odor, or other stimulus that may be perceived by the user either on a computer or on a printout or the like.

It should also be appreciated that the above-described methods, or portions thereof, may be embodied as machine readable code, object code, or source code contained on any suitable medium, including for example and without limitation a hard drive, a flash drive, a memory chip, a portable disk and the like. Additionally, the stimulus may, but need not be, contained by the same machine or processor that includes the color emotion measurement tool, non-cognitive questionnaire, and/or cognitive questionnaire, and it may be presented, played or shown to the respondent on any suitable display medium including for example and without limitation a computer, an mp3 player, a television set, CD player, DVD player, VCR player, a telephone, a radio, a personal data assistant, and the like.

While the disclosure has been illustrated and described in detail in the drawings and foregoing description, such an illustration and description is to be considered as illustrative and not restrictive in character, it being understood that only illustrative embodiments have been shown and described and that all changes and modifications that come within the spirit of the disclosure are desired to be protected.

There are a plurality of advantages of the present disclosure arising from the various features of the devices, systems, and methods described herein. It will be noted that alternative embodiments of the devices, systems, and methods of the present disclosure may not include all of the features described yet still benefit from at least some of the advantages of such features. Those of ordinary skill in the art may readily devise their own implementations of the devices, systems, and methods that incorporate one or more of the features of the present invention and fall within the spirit and scope of the present disclosure as defined by the appended claims.

1. A computer comprising:
a display;
a processor; and
a memory device electrically coupled to the processor, the memory device having stored therein a plurality of instructions that, when executed by the processor, cause the processor to:
display a stimulus to a user on the display;
display a color bar to the user on the display, the color bar including a plurality of different colors;
display a question related to the advertisement to the user on the display, the question requesting the user to select one of the colors of the color bar; and
receive a selection of one of the colors of the color bar made by the user in response to the question.

2. The computer of claim 1, wherein the stimulus is an advertisement.

3. The computer of claim 1, wherein the color bar comprises a plurality of icons, each icon having a color corresponding to one of the plurality of different colors.

4. The computer of claim 1, wherein the color bar comprises a grid of colored icons, the grid having a plurality of columns and at least two rows.

5. The computer of claim 4, wherein each column of the grid corresponds to a different color.

6. The computer of claim 5, wherein the grid includes a first row and a second row of colored icons, the color of each colored icon of the second row having a lesser intensity than the color of the corresponding colored icon of the first row of the same column.

7. The computer of claim 6, wherein the plurality of instructions further cause the processor to receive selections from a plurality of users and determine a percentage value indicative of the percentage of users that chose a particular intensity.

8. The computer of claim 4, wherein each colored icon is arranged in the grid based on the tone of the color of the colored icon.

9. The computer of claim 8, wherein each colored icon having a warm color tone is positioned toward a first end of the grid, each colored icon having a cool color tone is positioned toward the center of the grid, and each colored icon having a neutral color tone is positioned toward a second end of the grid opposite the first end.

10. The computer of claim 9, wherein the plurality of instructions further cause the processor to receive selections from a plurality of users and determine a percentage value indicative of the percentage of users that chose a particular color tone.

11. The computer of claim 1, wherein the color bar includes the following colors positioned in the following left-to-right arrangement: red, orange, yellow, pink, green, blue, purple, black, and white.

12. The computer of claim 1, wherein each color of the color bar is defined according to a predetermined 24-bit RGB representation.

13. The computer of claim 12, wherein the color bar includes colors defined by the following 24-bit RGB representations: (255, 0, 0); (255, 167, 167); (255, 102, 0); (255, 180, 129); (255, 255, 0); (255, 255, 129); (0, 176, 0); (133, 255, 133); (0, 0, 255); (139, 139, 255); (153, 0, 204); (186, 140, 220); (255, 0, 204); (255, 175, 240); (0, 0, 0); (173, 173, 173); (255, 255, 255); and (240, 240, 240).

14. The computer of claim 1, wherein the plurality of instructions further cause the processor to receive selections from a plurality of user and determine a percentage value indicative of the percentage of users that chose a particular color.

15. The computer of claim 14, wherein the plurality of instructions further cause the processor to associate an emotion with each color of the color bar.

16. A machine readable medium comprising a plurality of instructions, that in response to being executed, result in a computing device:
displaying a stimulus to a user on a display;
displaying a color bar to the user on the display, the color bar including a plurality of icons arranged in a grid, each icon being selectable by the user to indicate a selection of a color associated with the icon; and
receiving a selection of one of the icons by the user in response to the stimulus.

17. The machine readable medium of claim 16, wherein the grid includes:
a plurality of columns, each column corresponding to a different color,
a first row corresponding to high intensity colors; and
a second row corresponding to low intensity colors.

18. The machine readable medium of claim 16, wherein the icons are arranged in the grid based on the tone of the color of each icon.

19. The machine readable medium of claim 16, wherein the color bar includes icons having the following colors: red, orange, yellow, pink, green, blue, purple, black, and white.

20. The machine readable medium of claim 16, wherein each color of the icons are defined according to a predetermined 24-bit RGB representation.

21. A method for determining an emotional response of a user to a stimulus, the method comprising:
providing the stimulus to the user;
providing a color bar to the user, the color bar including a plurality of different colors;
identifying a color selected by the user in response to the stimulus; and
determining an emotional response metric of stimulus based on the color selected by the user.

22. The method of claim 21, wherein providing the stimulus to the user comprises displaying an advertisement to the user.

23. The method of claim 21, wherein providing a color bar to the user comprises providing a print medium to the user, the print medium having indicia located thereon representative of the color bar.

24. A survey instrument comprising:
a print medium substrate;
a plurality of differently colored icons defined on the print medium substrate, the plurality of differently colored icons being arranged in a grid; and
indicia defined on the print medium substrate, the indicia requesting a user of the survey instrument to select one of the differently colored icons.

25. The survey instrument of claim 24, wherein the plurality of differently colored icons are arranged in a grid having a plurality of columns and at least two rows, each column of the grid corresponding to a different color.

26. The survey instrument of claim 25, wherein the grid includes a first row and a second row of colored icons, the color of each colored icon of the second row having a lesser intensity than the color of the corresponding colored icon of the first row of the same column.

27. The survey instrument of claim 26, wherein each colored icon having a warm color tone is positioned toward a first end of the grid, each colored icon having a cool color tone is positioned toward the center of the grid, and each colored icon having a neutral color tone is positioned toward a second end of the grid opposite the first end.

28. The survey instrument of claim 27, wherein the color bar includes the following colors positioned in the following left-to-right arrangement: red, orange, yellow, pink, green, blue, purple, black, and white.

29. The survey instrument of claim 27, wherein the color bar includes the following colors positioned in the following left-to-right arrangement: red, orange, yellow, green, blue, purple, pink, black, and white.

30. The computer of claim 1, wherein the color bar includes the following colors positioned in the following left-to-right arrangement: red, orange, yellow, green, blue, purple, pink, black, and white

31. The machine readable medium of claim 16, wherein the color bar includes icons having the following colors positioned in the following left-to-right arrangement: red, orange, yellow, green, blue, purple, pink, black, and white.
